(19) United States
(12) Patent Application Publication
(10) Pub. No.: US 2023/0260512 A1
(43) Pub. Date: Aug. 17, 2023

(54) ELECTRONIC DEVICE AND METHOD OF ACTIVATING SPEECH RECOGNITION SERVICE

(71) Applicant: SAMSUNG ELECTRONICS CO., LTD., Suwon-si (KR)

(72) Inventors: Seyoon KIM, Suwon-si (KR); Gajin SONG, Suwon-si (KR); Hoseon SHIN, Suwon-si (KR); Joohwan KIM, Suwon-si (KR)

(21) Appl. No.: 18/093,978

(22) Filed: Jan. 6, 2023

Related U.S. Application Data
(63) Continuation of application No. PCT/KR2022/018159, filed on Nov. 17, 2022.

(30) Foreign Application Priority Data
Feb. 16, 2022 (KR) 10-2022-0019883
Dec. 1, 2022 (KR) 10-2022-0004699

(51) Int. Cl. G10L 15/22; G10L 15/18; G10L 15/06

(52) U.S. Cl. CPC G10L 15/22; G10L 15/063; G10L 15/1815; G10L 2015/088

(57) ABSTRACT

An electronic device includes a memory storing instructions, and at least one processor electrically connected to the memory and configured to execute the instructions, and when the at least one processor executes the instructions, the at least one processor may be configured to activate a speech recognition service in response to a first utterance including a default wake-up word, deactivate the speech recognition service after providing feedback on the first utterance, receive a second utterance following the first utterance within a predetermined period of time, and reactivate the speech recognition service based on a case where the second utterance includes a predictive wake-up word. In addition, various embodiments are possible.

### CROSS-REFERENCE TO RELATED APPLICATIONS

This application is a continuation application of International Application No. PCT/KR2022/018159 designating the U.S., filed on Nov. 17, 2022, in the Korean Intellectual Property Receiving Office and claiming priority to Korean Patent Application No. 10-2022-0004699, filed on Jan. 12, 2022 and Korean Patent Application No. 10-2022-0019883, filed on Feb. 16, 2022, in the Korean Intellectual Property Office, the disclosures of which are incorporated by reference herein in their entireties.

### BACKGROUND

### 1. Field

Certain example embodiments relate to an electronic device and/or a method of activating a speech recognition service.

### 2. Description of Related Art

Recently, voice assistant services have performed user’s commands based on speech recognition services. Most voice assistant services are activated by speech recognition of wake-up words, and the activated voice assistant services recognize and perform the user’s commands.

Each voice assistant service has a default wake-up word (e.g., Hi Bixby, Siri, or Alexa), and the default wake-up word is designated as a word that is not often used in daily life, in order to prevent unintended actions.

### SUMMARY

In order for a user to activate a speech recognition service, the user utters a command including a default wake-up word or press a designated button. Although the user utters a consecutive command in the same context, the user utters the command with the default wake-up word for every command and/or press the button for every command, in order to activate the speech recognition service. Technology for activating a speech recognition service, even when a user input having a similar context is continuously input, may be required.

An example embodiment of the disclosure may provide technology for activating a speech recognition service when continuous user utterances are received, although a follow-up utterance does not include a default wake-up word.

The example technical goals to be achieved are not limited to those described above, and other example technical goals not mentioned above are clearly understood by one of ordinary skill in the art from the following description.

According to an example embodiment, an electronic device may include a memory storing instructions, and a processor electrically connected to the memory and configured to execute the instructions, and wherein the processor executes the instructions. The processor may activate a speech recognition service based on (e.g., in response to) a first utterance including a default wake-up word, deactivate the speech recognition service after providing feedback on the first utterance, receive a second utterance following the first utterance within a predetermined period of time, and reactivate the speech recognition service based on (e.g., in response to) a case where the second utterance includes a predictive wake-up word.

According to an example embodiment, an electronic device may include a memory storing instructions, and a processor electrically connected to the memory and configured to execute the instructions. When the processor executes the instructions, the processor may be configured to activate a speech recognition service based on (e.g., in response to) a first utterance including a default wake-up word, generate a predictive wake-up word based on the first utterance, update a wake-up word list including the default wake-up word such that the wake-up word list includes the predictive wake-up word, receive a second utterance following the first utterance, and reactivate the speech recognition service based on (e.g., in response to) a case where the second utterance is in and/or matches to the wake-up word list.

According to an example embodiment, an electronic device may include a memory storing instructions, and a processor electrically connected to the memory and configured to execute the instructions. When the processor executes the instructions, the processor may be configured to receive a user input, generate a predictive wake-up word based on the user input, receive an utterance following the user input within a predetermined period of time, and activate a speech recognition service based on (e.g., in response to) a case where the utterance includes the predictive wake-up word.

An example embodiment may provide technology for activating a speech recognition service by generating a predictive wake-up word corresponding to a user input (e.g., a voice input, an action input, or an action on an external electronic device), although a follow-up utterance not including a default wake-up word is received after the user input.

In addition, various effects directly or indirectly ascertained through the present disclosure may be provided.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device in a network environment according to an example embodiment;

FIG. 2 is a block diagram illustrating an integrated intelligence system according to an example embodiment;

FIG. 3 is a diagram illustrating a form in which relationship information between concepts and actions is stored in a database according to an example embodiment;

FIG. 4 is a diagram illustrating a screen of an electronic device processing a received voice input through an intelligent app according to an example embodiment;

FIG. 5 is a diagram illustrating a concept in which an electronic device activates a speech recognition service according to an example embodiment;

FIG. 6 is a diagram illustrating an operation of generating by an electronic device a predictive wake-up word based on a user input according to an example embodiment;

FIG. 7 is a diagram illustrating a model for generating a predictive wake-up word according to an example embodiment;

FIG. 8 is a diagram illustrating examples in which an electronic device generates a predictive wake-up word based on a user input according to an example embodiment;

FIG. 9A is a diagram illustrating an example in which an electronic device activates a speech recognition service, even when an utterance not including a default wake-up word is received after a user input according to an example embodiment;

FIG. 9B is a diagram illustrating another example in which an electronic device activates a speech recognition service, even when an utterance not including a default wake-up word is received after a user input according to an example embodiment;

FIG. 9C is a diagram illustrating still another example in which an electronic device activates a speech recognition service, even when an utterance not including a default wake-up word is received after a user input according to an example embodiment;

FIG. 9D is a diagram illustrating still another example in which an electronic device activates a speech recognition service, even when an utterance not including a default wake-up word is received after a user input according to an example embodiment;

FIG. 10 is a diagram illustrating examples in which an electronic device provides feedback in response to a user input according to an example embodiment;

FIG. 11 is a flowchart illustrating an example of an operating method of an electronic device according to an example embodiment; and

FIG. 12 is a flowchart illustrating another example of the operating method of the electronic device according to an example embodiment.

FIG. 13 is a flowchart illustrating still another example of the operating method of the electronic device according to an example embodiment.

FIG. 14 is a flowchart illustrating a still another example of the operating method of the electronic device according to an example embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

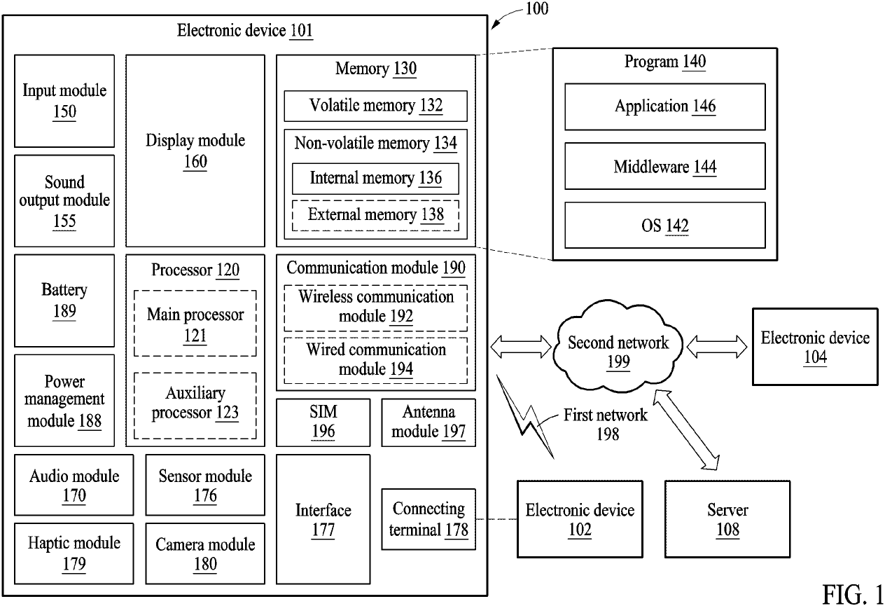

FIG. 1 is a block diagram illustrating an electronic device 101 in a network environment 100 according to an example embodiment. Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an example embodiment, the electronic device 101 may communicate with the electronic device 104 via the server 108. According to an example embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added to the electronic device 101. In some embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an example embodiment, as at least a part of data processing or computation, the processor 120 may store a command or data received from another component (e.g., the sensor module 176 comprising at least one senwor, or the communication module 190 comprising communication ciruitry) in a volatile memory 132, process the command or the data stored in the volatile memory 132, and store resulting data in a non-volatile memory 134. According to an example embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an example embodiment, the auxiliary processor 123 (e.g., an ISP or a CP) may be implemented as a portion of another component (e.g., the camera module 180 or the communication module 190) that is functionally related to the auxiliary processor 123. According to an example embodiment, the auxiliary processor 123 (e.g., an NPU) may include a hardware structure specified for artificial intelligence (AI) model processing. An AI model may be generated through machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an example embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an example embodiment, the display module 160 may include a touch sensor adapted to sense a touch, or a pressure sensor adapted to measure an intensity of a force incurred by the touch.

The audio module 170 may convert a sound into an electric signal and vice versa. According to an example embodiment, the audio module 170 may obtain the sound via the input module 150 or output the sound via the sound output module 155 or an external electronic device (e.g., an electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an example embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an example embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an example embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to an example embodiment, the haptic module 179 may include, for example, a motor, a piezoelectric element, or an electric stimulator.

The camera module 180 may capture a still image and moving images. According to an example embodiment, the camera module 180 may include one or more lenses, image sensors, ISPs, or flashes.

The power management module 188 may manage power supplied to the electronic device 101. According to an example embodiment, the power management module 188 may be implemented as, for example, at least a part of a power management integrated circuit (PMIC).

The battery 189 may supply power to at least one component of the electronic device 101. According to an example embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support a direct (e.g., wired) communication or a wireless communication. According to an example embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an example embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., an external electronic device) of the electronic device 101. According to an example embodiment, the antenna module 197 may include an antenna including a radiating element including a conductive material or a conductive pattern formed in or on a substrate (e.g., a printed circuit board (PCB)). According to an example embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an example embodiment, another component (e.g., a radio frequency integrated circuit (RFIC)) other than the radiating element may be additionally formed as a part of the antenna module 197.

According to an example embodiment, the antenna module 197 may form a mmWave antenna module. According to an example embodiment, the mmWave antenna module may include a PCB, an RFIC disposed on a first surface (e.g., a bottom surface) of the PCB or adjacent to the first surface and capable of supporting a designated a high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an example embodiment, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or MEC. In an example embodiment, the external electronic device 104 may include an Internet-of-things (IoT) device. The server 108 may be an intelligent server using machine learning and/or a neural network. According to an example embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to embodiments may be one of various types of electronic devices. The electronic device may include, for example, a portable communication device (e.g., a smartphone), a computer device, a portable multimedia device, a portable medical device, a camera, a wearable device, or a home appliance device. According to an example embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. Terms such as “1^{st},” “2^{nd},” or “first” or “second” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., by wire), wirelessly, or via at least a third element.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an example embodiment, the module may be implemented in a form of an application-specific integrated circuit (ASIC). Thus, each “module” herein may comprise circuitry.

Embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an example embodiment, a method may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer’s server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

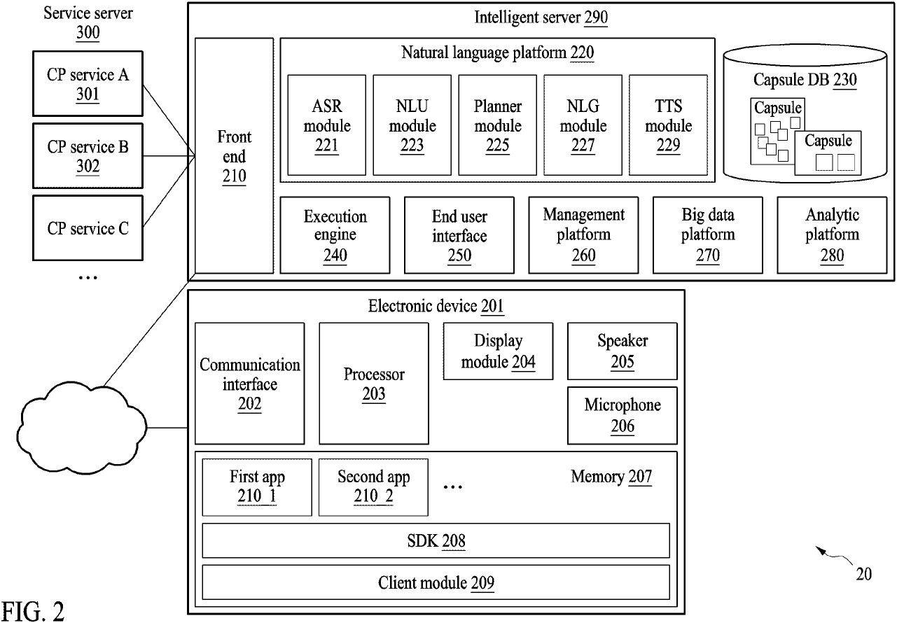

FIG. 2 is a block diagram illustrating an integrated intelligence system according to an example embodiment.

Referring to FIG. 2, an integrated intelligence system 20 according to an example embodiment may include an electronic device 201 (e.g., the electronic device 101 of FIG. 1), an intelligent server 200 (e.g., the server 108 of FIG. 1), and a service server 300 (e.g., the server 108 of FIG. 1).

The electronic device 201 may be a terminal device (or an electronic device) connectable to the Internet, and may be, for example, a mobile phone, a smartphone, a personal digital assistant (PDA), a notebook computer, a TV, a white home appliance, a wearable device, a head-mounted display (HMD), or a smart speaker.

According to the shown embodiment, the electronic device 201 may include a communication interface 202 (e.g., the interface 177 of FIG. 1), a microphone 206 (e.g., the input module 150 of FIG. 1), a speaker 205 (e.g., the sound output module 155 of FIG. 1), a display module 204 (e.g., the display module 160 of FIG. 1, including at least one display), a memory 207 (e.g., the memory 130 of FIG. 1), or a processor 203 (e.g., the processor 120 of FIG. 1). The components listed above may be operationally or electrically connected to each other.

The communication interface 202 may be connected, directly or indirectly, to an external device and configured to transmit and receive data to and from the external device. The microphone 206 may receive a sound (e.g., a user utterance) and convert the sound into an electrical signal. The speaker 205 may output the electrical signal as a sound (e.g., a speech).

The display module 204 may be configured to display an image or video. The display module 204 may also display a graphical user interface (GUI) of an app (or an application program) being executed. The display module 204 may receive a touch input through a touch sensor. For example, the display module 204 may receive a text input through a touch sensor in an on-screen keyboard area displayed in the display module 204 which includes a display.

The memory 207 may store a client module 209, a software development kit (SDK) 208, and a plurality of apps 210. The client module 209 and the SDK 208 may configure a framework (or a solution program) for performing general-purpose functions. In addition, the client module 209 or the SDK 208 may configure a framework for processing a user input (e.g., a voice input, a text input, or a touch input).

The plurality of apps 210 stored in the memory 207 may be programs for performing designated functions. According to an example embodiment, the plurality of apps 210 may include a first app 210_1 and a second app 210_2. According to an example embodiment, each of the plurality of apps 210 may include a plurality of actions for performing a designated function. For example, the apps may include an alarm app, a messaging app, and/or a scheduling app. According to an example embodiment, the plurality of apps 210 may be executed by the processor 203 to sequentially execute at least a portion of the plurality of actions.

The processor 203 may control the overall operation of the electronic device 201. For example, the processor 203 may be electrically connected, directly or indirectly, to the concatenation interface 202, the microphone 206, the speaker 205, and the display module 204 to perform a designated operation.

The processor 203 may also perform the designated function by executing the program stored in the memory 207. For example, the processor 203 may execute at least one of the client module 209 or the SDK 208 to perform the following operation for processing a user input. The processor 203 may control the operation of the plurality of apps 210 through, for example, the SDK 208. The following operation which is the operation of the client module 209 or the SDK 208 may be performed by the processor 203.

The client module 209 may receive a user input. For example, the client module 209 may receive a voice signal corresponding to a user utterance sensed through the microphone 206. As another example, the client module 209 may receive a touch input sensed through the display module 204. As still another example, the client module 209 may receive a text input sensed through a keyboard or an on-screen keyboard. In addition, the client module 209 may receive various types of user inputs sensed through an input module included in the electronic device 201 or an input module connected, directly or indirectly, to the electronic device 201. The client module 209 may transmit the received user input to the intelligent server 200. The client module 209 may transmit state information of the electronic device 201 together with the received user input to the intelligent server 200. The state information may be, for example, execution state information of an app.

The client module 209, comprising circuitry, may receive a result corresponding to the received user input. For example, when the intelligent server 200 is capable of calculating a result corresponding to the received user input, the client module 209 may receive the result corresponding to the received user input. The client module 209 may display the received result on the display module 204. Further, the client module 209 may output the received result in an audio form through the speaker 205.

The client module 209 may receive a plan corresponding to the received user input. The client module 209 may display results of executing a plurality of actions of an app according to the plan on the display module 204 which comprises a display. For example, the client module 209 may sequentially display the results of executing the plurality of actions on the display module 204 and output the results in an audio form through the speaker 205. As another example, the electronic device 201 may display only a portion of the results of executing the plurality of actions (e.g., a result of the last action) on the display module 204 and output the portion of the results in an audio form through the speaker 205.

According to an example embodiment, the client module 209 may receive a request for obtaining information necessary for calculating a result corresponding to the user input from the intelligent server 200. According to an example embodiment, the client module 209 may transmit the necessary information to the intelligent server 200 in response to the request.

The client module 209 may transmit information on the results of executing the plurality of actions according to the plan to the intelligent server 200. The intelligent server 200 may confirm that the received user input has been correctly processed using the information on the results.

The client module 209 may include a speech recognition module. According to an example embodiment, the client module 209 may recognize a voice input for performing a limited function through the speech recognition module. For example, the client module 209 may execute an intelligent app for processing a voice input to perform an organic operation through a designated input (e.g., Wake up!).

The intelligent server 200 may receive information related to a user voice input from the electronic device 201 through a communication network. According to an example embodiment, the intelligent server 200 may change data related to the received voice input into text data. According to an example embodiment, the intelligent server 200 may generate a plan for performing a task corresponding to the user voice input based on the text data.

According to an example embodiment, the plan may be generated by an AI system. The AI system may be a rule-based system or a neural network-based system (e.g., a feedforward neural network (FNN) or a recurrent neural network (RNN)). Alternatively, the AI system may be a combination thereof or other AI systems. According to an example embodiment, the plan may be selected from a set of predefined plans or may be generated in real time in response to a user request. For example, the AI system may select at least one plan from among the predefined plans.

The intelligent server 200 may transmit a result according to the generated plan to the electronic device 201 or transmit the generated plan to the electronic device 201. According to an example embodiment, the electronic device 201 may display the result according to the plan on the display module 204. According to an example embodiment, the electronic device 201 may display a result of executing an action according to the plan on the display module 204.

The intelligent server 200 may include a front end 210, a natural language platform 220, a capsule database (DB) 230, an execution engine 240, an end user interface 250, a management platform 260, a big data platform 270, or an analytic platform 280.

The front end 210 may receive the received user input from the electronic device 201. The front end 210 may transmit a response corresponding to the user input.

According to an example embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert the voice input received from the electronic device 201 into text data. The NLU module 223 may discern a user intent using the text data of the voice input. For example, the NLU module 223 may discern the intent of the user by performing syntactic analysis or semantic analysis on a user input in the form of text data. The NLU module 223 may discern the meaning of a word extracted from the user input using a linguistic feature (e.g., a grammatical element) of a morpheme or phrase, and determine the intent of the user by matching the discerned meaning of the word to an intent.

The planner module 225 may generate a plan using a parameter and the intent determined by the NLU module 223. According to an example embodiment, the planner module 225 may determine a plurality of domains required to perform a task based on the determined intent. The planner module 225 may determine a plurality of actions included in each of the plurality of domains determined based on the intent. According to an example embodiment, the planner module 225 may determine a parameter required to execute the determined plurality of actions or a result value output by the execution of the plurality of actions. The parameter and the result value may be defined as a concept of a designated form (or class). Accordingly, the plan may include a plurality of actions and a plurality of concepts determined by the user intent. The planner module 225 may determine a relationship between the plurality of actions and the plurality of concepts stepwise (or hierarchically). For example, the planner module 225 may determine an execution order of the plurality of actions determined based on the user intent, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) between the plurality of actions and the plurality of concepts. The planner module 225 may generate the plan using information stored in the capsule DB 230 that stores a set of relationships between concepts and actions.

The NLG module 227 may change designated information into a text form. The information changed to the text form may be in the form of a natural language utterance. The TTS module 229 may change information in a text form into information in a speech form.

According to an example embodiment, some or all of the functions of the natural language platform 220 may be implemented in the electronic device 201 as well.

The capsule DB 230 may store information on the relationship between the plurality of concepts and actions corresponding to the plurality of domains. A capsule according to an example embodiment may include a plurality of action objects (or action information) and concept objects (or concept information) included in the plan. According to an example embodiment, the capsule DB 230 may store a plurality of capsules in the form of a concept action network (CAN). According to an example embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when there are a plurality of plans corresponding to the user input. According to an example embodiment, the capsule DB 230 may include a follow-up registry that stores information on follow-up actions for suggesting a follow-up action to the user in a designated situation. The follow-up action may include, for example, a follow-up utterance. According to an example embodiment, the capsule DB 230 may include a layout registry that stores layout information that is information output through the electronic device 201. According to an example embodiment, the capsule DB 230 may include a vocabulary registry that stores vocabulary information included in capsule information. According to an example embodiment, the capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a current set objective, a preference of the user, or an environmental condition. In an example embodiment, the capsule DB 230 may be implemented in the electronic device 201 as well.

The execution engine 240 may calculate a result using the generated plan. The end user interface 250 may transmit the calculated result to the electronic device 201. Accordingly, the electronic device 201 may receive the result and provide the received result to the user. The management platform 260 may manage information used by the intelligent server 200. The big data platform 270 may collect data of the user. The analytic platform 280 may manage a quality of service (QoS) of the intelligent server 200. For example, the analytic platform 280 may manage the components and processing rate (or efficiency) of the intelligent server 200.

The service server 300 may provide a designated service (e.g., food order or hotel reservation) to the electronic device 201. According to an example embodiment, the service server 300 may be a server operated by a third party. The service server 300 may provide information to be used for generating a plan corresponding to the received user input to the intelligent server 200. The provided information may be stored in the capsule DB 230. In addition, the service server 300 may provide result information according to the plan to the intelligent server 200.

In the integrated intelligence system 20 described above, the electronic device 201 may provide various intelligent services to the user in response to a user input. The user input may include, for example, an input through a physical button, a touch input, or a voice input.

In an example embodiment, the electronic device 201 may provide a speech recognition service through an intelligent app (or a speech recognition app) stored therein. In this case, for example, the electronic device 201 may recognize a user utterance or a voice input received through the microphone, and provide a service corresponding to the recognized voice input to the user.

In an example embodiment, the electronic device 201 may perform a designated action alone or together with the intelligent server and/or a service server, based on the received voice input. For example, the electronic device 201 may execute an app corresponding to the received voice input and perform a designated action through the executed app.

In an example embodiment, when the electronic device 201 provides a service together with the intelligent server 200 and/or the service server 300, the electronic device 201 may detect a user utterance using the microphone 206 and generate a signal (or voice data) corresponding to the detected user utterance. The electronic device 201 may transmit the voice data to the intelligent server 200 using the communication interface 202.

The intelligent server 200 may generate, as a response to the voice input received from the electronic device 201, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may define parameters input to the execution of the plurality of actions or result values output by the execution of the plurality of actions. The plan may include connection information between the plurality of actions and the plurality of concepts.

The electronic device 201 may receive the response using the communication interface 202. The electronic device 201 may output a voice signal internally generated by the electronic device 201 to the outside using the speaker 205, or output an image internally generated by the electronic device 201 to the outside using the display module 204.

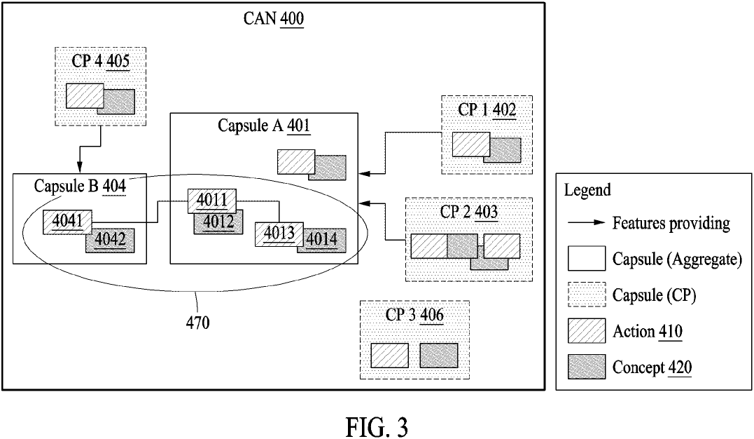

FIG. 3 is a diagram illustrating a form in which relationship information between concepts and actions is stored in a DB according to an example embodiment.

A capsule DB (e.g., the capsule DB 230) of the intelligent server 200 may store capsules in the form of a CAN 400. The capsule DB may store an action for processing a task corresponding to a voice input of a user and a parameter necessary for the action in the form of a CAN.

The capsule DB may store a plurality of capsules (a capsule A 401 and a capsule B 404) respectively corresponding to a plurality of domains (e.g., applications). According to an example embodiment, one capsule (e.g., the capsule A 401) may correspond to one domain (e.g., a location (geo) or an application). Further, the one capsule may correspond to at least one service provider (e.g., CP 1402 or CP 2 403) for performing a function for a domain related to the capsule. According to an example embodiment, one capsule may include at least one or more actions 410 for performing a designated function and at least one or more concepts 420.

The natural language platform 220 may generate a plan for performing a task corresponding to the received voice input using the capsules stored in the capsule DB. For example, the planner module 225 of the natural language platform 220 may generate the plan using the capsules stored in the capsule DB. For example, a plan 470 may be generated using actions 4011 and 4013 and concepts 4012 and 4014 of the capsule A 401 and an action 4041 and a concept 4042 of the capsule B 404.

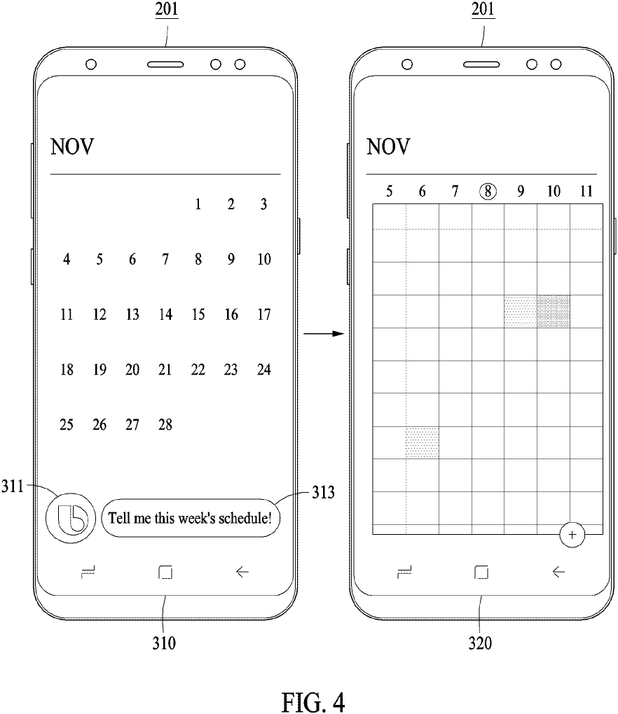

FIG. 4 is a diagram illustrating a screen of an electronic device processing a received voice input through an intelligent app according to an example embodiment.

The electronic device 201 may execute an intelligent app to process a user input through the intelligent server 200.

According to an example embodiment, on a screen 310, when a designated voice input (e.g., Wake up!) is recognized or an input through a hardware key (e.g., a dedicated hardware key) is received, the electronic device 201 may execute an intelligent app for processing the voice input. The electronic device 201 may execute the intelligent app, for example, in a state in which a scheduling app is executed. According to an example embodiment, the electronic device 201 may display an object (e.g., an icon) 311 corresponding to the intelligent app on the display module 204. According to an example embodiment, the electronic device 201 may receive a voice input by a user utterance. For example, the electronic device 201 may receive a voice input of “Tell me this week’s schedule!”. According to an example embodiment, the electronic device 201 may display a user interface (UI) 313 (e.g., an input window) of the intelligent app in which text data of the received voice input is displayed on the display module 204.

According to an example embodiment, on a screen 320, the electronic device 201 may display a result corresponding to the received voice input on the display module 204. For example, the electronic device 201 may receive a plan corresponding to the received user input, and display “this week’s schedule” on the display module 204 according to the plan.

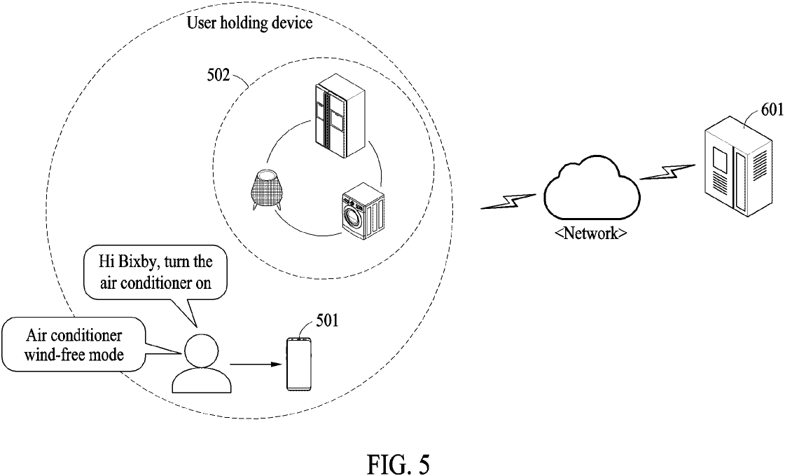

FIG. 5 is a diagram illustrating a concept that an electronic device activates a speech recognition service according to an example embodiment.

Referring to FIG. 5, according to an example embodiment, an electronic device 501 (e.g., the electronic device 101 of FIG. 1 or the electronic device 201 of FIG. 2) and one or more peripheral devices 502 may be connected to each other via a LAN, a WAN, a value added network (VAN), a mobile radio communication network, a satellite communication network, or a combination thereof. The electronic devices 501 and 502 may communicate with each other by a wired communication method or a wireless communication method (e.g., wireless LAN (Wi-Fi), Bluetooth, Bluetooth low energy, Zigbee, Wi-Fi Direct (WFD), ultra wide band (UWB), IrDA, and near field communication (NFC)). The electronic device 501 may be connected to the peripheral device 502 via a gateway or a relay or may be directly connected to the peripheral device 502. In addition, the electronic device 501 may be connected to the peripheral device 502 via a server (e.g., the intelligent server 200 of FIG. 2).

According to an example embodiment, the devices 501 and 502 may be implemented as at least one of a smartphone, a tablet personal computer (PC), a mobile phone, a speaker (e.g., an AI speaker), a video phone, an e-book reader, a desktop PC, a laptop PC, a netbook computer, a workstation, a server, a PDA, a portable multimedia player (PMP), an MP3 player, a mobile medical device, a camera, or a wearable device. In addition, the devices 501 and 502 may be home appliances. For example, a home appliance may include at least one of a television, a digital video disk (DVD) player, an audio system, a refrigerator, an air conditioner, a vacuum cleaner, an oven, a microwave oven, a washing machine, an air purifier, a set-top box, a home automation control panel, a security control panel, a game console, an electronic key, a camcorder, or an electronic picture frame.

According to an example embodiment, the devices 501 and 502 may be holding devices held by a user. The electronic device 501 may be a listening device that receives a user utterance (e.g., a command). The one or more peripheral devices 502 may be adjacent devices in the vicinity of the electronic device 501.

According to an example embodiment, an IoT server 601 may obtain, store, and manage device information (e.g., a device ID, a device type, function performance ability information, location information (e.g., registered place information), or state information) on the devices (e.g., the electronic device 501 and the peripheral device 502) held by the user. The electronic device 501 and the peripheral device 502 may be devices previously registered in the IoT server 601 in relation to user account information (e.g., a user ID).

According to an example embodiment, the function performance ability information among the device information may be information on a function of a device that is predefined to perform an operation. For example, when the device is an air conditioner, the function performance ability information of the air conditioner may indicate a function, such as a temperature increase, a temperature decrease, or air purification, and when the device is a speaker, the function performance ability information of the speaker may indicate a function, such as a volume increase, a volume decrease, or music play. Among the device information, the location information (e.g., registered place information) is information indicating a location (e.g., a registration location) of the device, and may include a name of a place, where the device is positioned, and a location coordinate value indicating the location of the device. For example, the location information of the device may include a name indicating a designated place in a house, such as a room or living room, or may include a name of a place, such as a house or an office. For example, the location information of the device may include geo-fence information.

Among the device information, the state information of the device may be information indicating a current state of the device including at least one of, for example, power on/off information or action information that is currently being performed.

According to an example embodiment, the IoT server 601 may obtain, determine, or generate a control command for controlling the device by using the stored device information. The IoT server 601 may transmit a control command to a device determined to perform an action, based on the action information. The IoT server 601 may receive, from the device which has performed the action, a result of performing the action according to the control command. The IoT server 601 may be configured as a hardware device independent from the intelligent server (e.g., the intelligent server 200 of FIG. 2), but is not limited thereto. The IoT server 601 may be a component of the intelligent server (e.g., the intelligent server 200 of FIG. 2) or a server designed to be classified as software.

According to an example embodiment, the electronic device 501 may activate the speech recognition service in response to a first utterance (e.g., “Hi Bixby, turn the air conditioner on”) including a default wake-up word (e.g., Hi Bixby) and deactivate the speech recognition service after providing feedback (e.g., turning the air conditioner on) on the first utterance (e.g., “Hi Bixby, turn the air conditioner on”). The electronic device 501 may receive a second utterance (e.g., “Air conditioner wind-free mode”) following the first utterance (e.g., “Hi Bixby, turn the air conditioner on”) within a predetermined period of time and reactivate the speech recognition service based on a case where the second utterance (e.g., “Air conditioner wind-free mode”) includes a predictive wake-up word (e.g., air conditioner wind-free, air conditioner powerful mode, turn the air conditioner off, or how’s the weather?).

According to an example embodiment, the electronic device 501 may activate the speech recognition service in response to the first utterance (e.g., “Hi Bixby, turn the air conditioner on”) including the default wake-up word (e.g., Hi Bixby) and generate the predictive wake-up word (e.g., air conditioner wind-free, air conditioner powerful mode, turn the air conditioner off, or how’s the weather?) based on the first utterance (e.g., “Hi Bixby, turn the air conditioner on”). The electronic device 501 may update a wake-up word list (e.g., Hi Bixby, air conditioner wind-free, air conditioner powerful mode, turn the air conditioner off, and how’s the weather?) such that the wake-up word list including the default wake-up word (e.g., Hi Bixby) includes the predictive wake-up words (e.g., air conditioner wind-free, air conditioner powerful mode, turn the air conditioner off, and how’s the weather?). The electronic device 501 may receive the second utterance (e.g., “Air conditioner wind-free mode”) following the first utterance (e.g., “Hi Bixby, turn the air conditioner on”) and reactivate the speech recognition service based on a case where the second utterance (e.g., “Air conditioner wind-free mode”) matches to the wake-up word list (e.g., Hi Bixby, air conditioner wind-free, air conditioner powerful mode, turn the air conditioner off, and how’s the weather?). For example, the electronic device 501 may reactivate the speech recognition service based on a case where a wake-up word (e.g., air conditioner wind-free) included in the wake-up word list (e.g., Hi Bixby, air conditioner wind-free, air conditioner powerful mode, turn the air conditioner off, and how’s the weather?) is included in the second utterance (e.g., “Air conditioner wind-free mode”).

According to an example embodiment, the electronic device 501 may provide technology for activating the speech recognition service when the continuous user utterances are received from the user, although a follow-up utterance does not include a default wake-up word. In addition, the electronic device 501 may provide technology for activating the speech recognition service by generating a predictive wake-up word corresponding to a user input every time, although a follow-up utterance not including a default wake-up word is received after the user input.

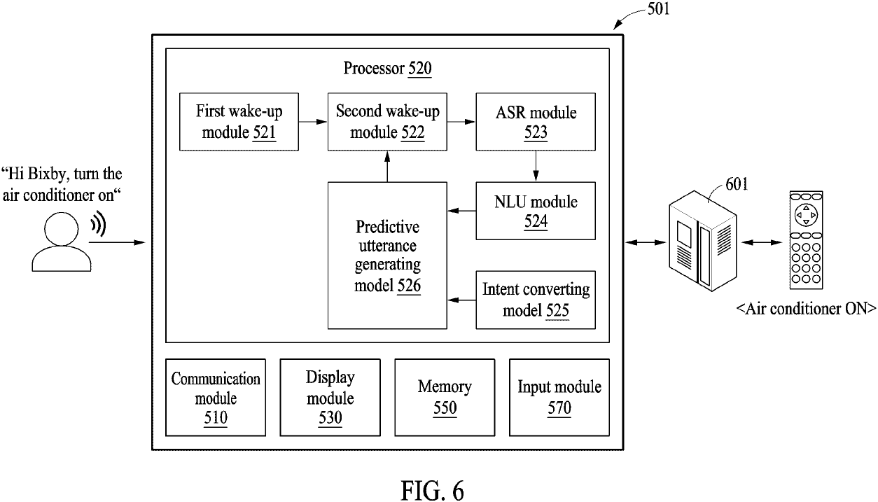

FIG. 6 is a diagram illustrating an operation of generating by an electronic device a predictive wake-up word based on a user input according to an example embodiment.

Referring to FIG. 6, according to an example embodiment, the electronic device 501 may generate a predictive wake-up word based on a user input. The user input may be a voice input (e.g., “Hi Bixby, turn the air conditioner on”), an action input to perform a task through the electronic device 501 (e.g., executing a weather app through the electronic device 501), or an action on an external electronic device performed outside the electronic device 501 (e.g., controlling the air conditioner by using an air conditioner remote control).

According to an example embodiment, the electronic device 501 may obtain a user intent and a domain based on a user input and generate a predictive wake-up word, based on the user intent and the domain. The electronic device 501 may generate a first intent considering action data of a user (e.g., all users or an individual user) associated with the domain and may generate a second intent considering utterance data of a user (e.g., all users or an individual user) associated with the domain. The electronic device 501 may generate a predictive utterance based on the utterance data of the user (e.g., an individual user or all users) associated with the first intent and the second intent and set the predictive utterance to a predictive wake-up word, thereby generating the predictive wake-up word.

According to an example embodiment, the electronic device 501 may include a communication module 510 (e.g., the communication module 190 of FIG. 1 and the communication interface 202 of FIG. 2), a processor 520 (e.g., the processor 120 of FIG. 1 and the processor 203 of FIG. 2), a display module 530 (e.g., the display module 160 of FIG. 1 and the display module 204 of FIG. 2), a memory 550 electrically connected, directly or indirectly, to the processor 520 (e.g., the memory 130 of FIG. 1 and the memory 207 of FIG. 2), and an input module 570 (e.g., the input module 150 of FIG. 1 and the microphone 206 of FIG. 2). A first wake-up module 521, a second wake-up module 522, an ASR module 523, a NLU module 524, an intent converting model 525, and a predictive utterance generating model 526 are executable by the processor 520, and may be configured with one or more of program code including instructions storable in the memory 550, an application, an algorithm, a routine, a set of instructions, and an AI learning model. In addition, at least one or more of the first wake-up module 521, the second wake-up module 522, the ASR module 523, the NLU module 524, the intent converting model 525, and the predictive utterance generating model 526 may be implemented by hardware or a combination of hardware and software and may be implemented in an intelligent server (e.g., the intelligent server 200 of FIG. 2).

According to an example embodiment, the first wake-up module 521 may recognize a user utterance (e.g., “Hi Bixby, turn the air conditioner on”) including a default wake-up word (e.g., High Bixby) and activate the processor 520.

According to an example embodiment, the second wake-up module 522 may recognize the user utterance including the wake-up word included in the wake-up word list and transmit the user utterance to the ASR module 523. As the second wake-up module 522 recognizes the user utterance, the speech recognition service may be activated. The wake-up word list may include a default wake-up word and/or a predictive wake-up word. The default wake-up word is set as a default to activate the speech recognition service and may be a word that is not often used in daily life, in order to prevent unintended actions (e.g., Hi Bixby). The predictive wake-up word may be for activating the speech recognition service only within a predetermined period of time and may be for activating the speech recognition service when continuous user inputs are received. The wake-up word list may be initialized when the default wake-up word is recognized or when the predetermined period of time has elapsed. For example, in the wake-up word list, the default wake-up word may be maintained and a previously generated predictive wake-up word may be initialized (or removed). The predetermined period of time may be a period of time taken until the processor 520 in an activated state is deactivated (e.g., 5 seconds to 10 seconds after a screen (e.g., the display module 204 of FIG. 2) of the electronic device 501 is turned off).

According to an example embodiment, the ASR module 523 (e.g., the ASR module 221 of FIG. 2) may convert a voice input received from the electronic device 501 into text data.

According to an example embodiment, the NLU module 524 (e.g., the NLU module 223 of FIG. 2) may discern a user intent by using the text data of the voice input. For example, the NLU module 524 may obtain the user intent by performing syntactic analysis or semantic analysis on a user input in the form of text data.

According to an example embodiment, the intent converting model 525 may obtain a user intent, based on an action input for performing a task through the electronic device 501 and/or an action on an external electronic device performed outside the electronic device 501. For example, the intent converting model 525 may convert the execution of a weather app on the electronic device 501 into the user intent. In another example, the intent converting model 525 may convert the operation of the air conditioner performed via an air conditioner remote control into the user intent. The electronic device 501 may obtain information on the action on the external electronic device performed outside the electronic device 501 via the IoT server 601 and generate the predictive wake-up word by using the user input (e.g., the action input for performing the task through the electronic device 501 and the action on the external electronic device performed outside the electronic device 501) except for the voice input through the intent converting model 525.

According to an example embodiment, the predictive utterance generating model 526 may generate a predictive wake-up word based on a user intent and a domain. The user intent corresponds to the user input and may be obtained from the NLU module 524 and/or the intent converting model 525. The domain (e.g., an application) is required to perform a task based on a user intent, and information on the domain may be obtained from a planner module (e.g., the planner module 225 of FIG. 2). The predictive utterance generating model 526 may generate a first intent, based on the user intent and action data of a user (e.g., all users or an individual user) associated with the domain, and generate a second intent, based on the user intent and utterance data of a user (e.g., all users or an individual user) associated with the domain. The electronic device 501 may generate a predictive utterance based on utterance data of a user (e.g., an individual user or all users) associated with the first intent and the second intent, and set the predictive utterance to a predictive wake-up word, thereby generating the predictive wake-up word.

According to an example embodiment, the electronic device 501 may reduce inconvenience that the user always needs to make an utterance with the default wake-up word to instruct a voice command. As the electronic device 501 predicts a follow-up utterance based on a user input and sets the predicted follow-up utterance to the predictive wake-up word, the user may naturally continue the command without uttering the default wake-up word.

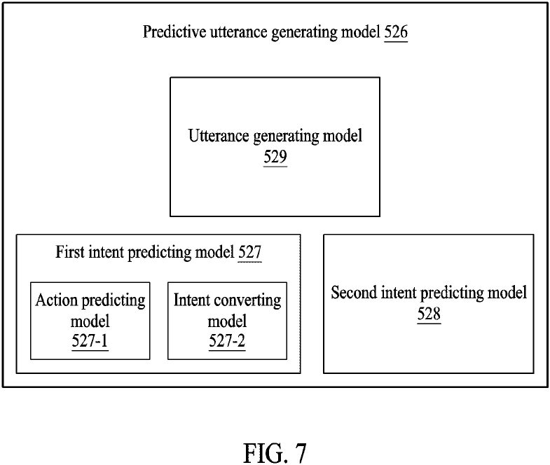

FIG. 7 is a diagram illustrating a model for generating a predictive wake-up word according to an example embodiment.

Referring to FIG. 7, according to an example embodiment, the predictive utterance generating model 526 may predict a follow-up utterance based on a user input (e.g., a voice input, an action input, or an action on an external electronic device) and set the predicted follow-up utterance to a predictive wake-up word, thereby generating the predictive wake-up word. The predictive utterance generating model 526 may include a first intent predicting model 527, a second intent predicting model 528, and an utterance generating model 529.

According to an example embodiment, the first intent predicting model 527 may generate a first intent considering action data of a user (e.g., all users or an individual user) associated with a domain corresponding to a user input. The first intent predicting model 527 may include a plurality of models (not shown) to predict a follow-up action for each domain, and the plurality of models may respectively correspond to a plurality of domains. The first intent predicting model 527 may include an action predicting model 527-1 and an intent converting model 527-2. The action predicting model 527-1 may generate a predictive action, based on the user intent and the action data a user (e.g., all users or an individual user) associated with the domain. The intent converting model 527-2 may convert the predictive action into a user intent. The first intent predicting model 527 may generate the first intent, based on the user intent and action data of a user (e.g., all users or an individual user) associated with the domain.

According to an example embodiment, the second intent predicting model 528 may generate a second intent considering utterance data of a user (e.g., all users or an individual user) associated with a domain corresponding to a user input. The second intent predicting model 528 may generate the second intent, based on a user intent and utterance data of a user (e.g., all users or an individual user) associated with the domain.

According to an example embodiment, the utterance generating model 529 may generate a predictive utterance in consideration of the utterance data of a user (e.g., an individual user or all users). The utterance generating model 529 may generate the predictive utterance based on the utterance data of a user (e.g., an individual user or all users) associated with the first intent and the second intent. The predictive utterance generating model 526 may generate a predictive wake-up word by setting the predictive utterance to the predictive wake-up word.

According to an example embodiment, the predictive utterance generating model 526 may predict a follow-up user intent considering the action data and/or the utterance data of a user (e.g., all users or an individual user) associated with the domain corresponding to the user input and predict a follow-up user utterance considering the utterance data of a user (e.g., an individual user or all users) associated with the follow-up user intent, thereby generating a high-quality predictive wake-up word.

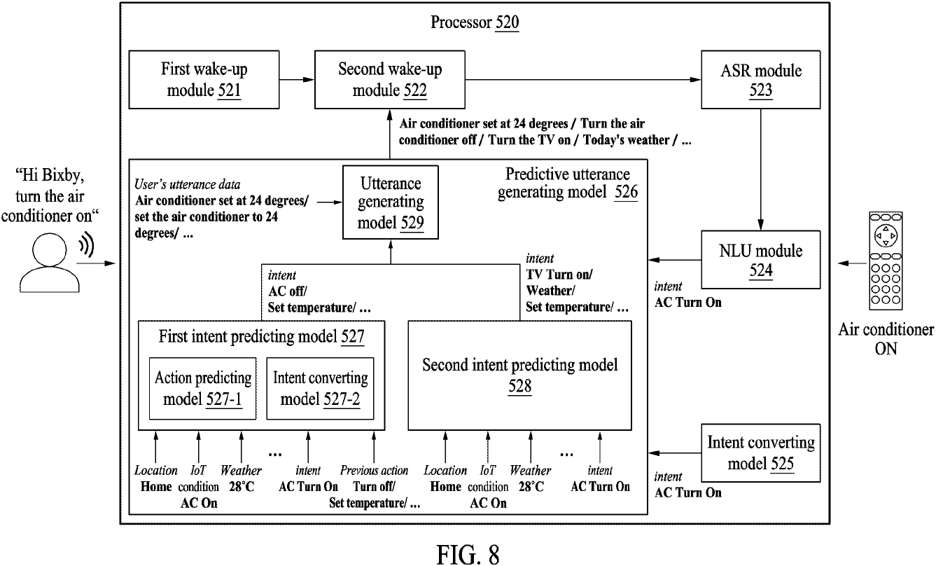

FIG. 8 is a diagram illustrating examples in which an electronic device generates a predictive wake-up word based on a user input according to an example embodiment.

Referring to FIG. 8, according to an example embodiment, the first wake-up module 521 may recognize a user utterance (e.g., “Hi Bixby, turn the air conditioner on”) including a default wake-up word (e.g., Hi Bixby) to activate the processor 520.

According to an example embodiment, the second wake-up module 522 may recognize a user utterance (e.g., “Hi Bixby, turn the air conditioner on”) and transmit the user utterance to the ASR module 523. As the second wake-up module 522 recognizes the user utterance, the speech recognition service may be activated.

According to an example embodiment, the ASR module 523 (e.g., the ASR module 221 of FIG. 2) may convert the voice input (e.g., “Hi Bixby, turn the air conditioner on”) received from the electronic device 501 into text data.

According to an example embodiment, the NLU module 524 (e.g., the NLU module 223 of FIG. 2) may obtain the user intent (e.g., AC Turn On) by performing syntactic analysis or semantic analysis on the user input in the form of the text data and output the user intent to the predictive utterance generating model 526.

According to an example embodiment, the intent converting model 525 may obtain a user intent, based on an action input for performing a task through the electronic device 501 and/or an action on an external electronic device performed outside the electronic device 501. For example, the intent converting model 525 may convert the operation of the air conditioner performed via the air conditioner remote control into the user intent (e.g., AC Turn On) and output the user intent to the predictive utterance generating model 526.

According to an example embodiment, the predictive utterance generating model 526 may generate a predictive wake-up word (e.g., air conditioner set at 24 degrees, turn the air conditioner off, turn the TV on, or today’s weather) based on the user intent (e.g., AC Turn On) and the domain (e.g., IoT domain). The user intent (e.g., AC Turn On) may correspond to a user input (e.g., the utterance of “Hi Bixby, turn on the air conditioner” or an action of turning the air conditioner on using the air conditioner remote control) and may be obtained from the NLU module 524 or the intent converting model 525. The first intent predicting model 527 may generate a first intent (e.g., AC off, Set temperature), based on action data (e.g., Turn off, Set temperature) of a user (e.g., all users or an individual user) associated with a domain (e.g., the IoT domain), a user intent (e.g., AC Turn On), and information on the user (e.g., Location: Home, IoT condition: AC On, Weather: 28° C.). The second intent predicting model 528 may generate a second intent (e.g., TV Turn on, the Weather, Set temperature), based on utterance data of a user (e.g., all users or an individual user) associated with a domain (e.g., the IoT domain), a user intent (e.g., AC Turn On), and information on the user (e.g., Location: Home, IoT condition: AC On, Weather: 28° C.). The utterance generating model 529 may generate a predictive utterance (e.g., air conditioner set at 24 degrees, turn the air conditioner off, turn the TV on, or today’s weather) based on utterance data (e.g., air conditioner set at 24 degrees or set the air conditioner to 24 degrees) of a user (e.g., all users or an individual user) associated with the first intent (e.g., AC off, Set temperature) and the second intent (e.g., TV Turn on, the Weather, Set temperature). The predictive utterance generating model 526 may generate a predictive wake-up word (e.g., air conditioner set at 24 degrees, turn the air conditioner off, turn the TV on, or today’s weather) by setting the predictive utterance to the predictive wake-up word.

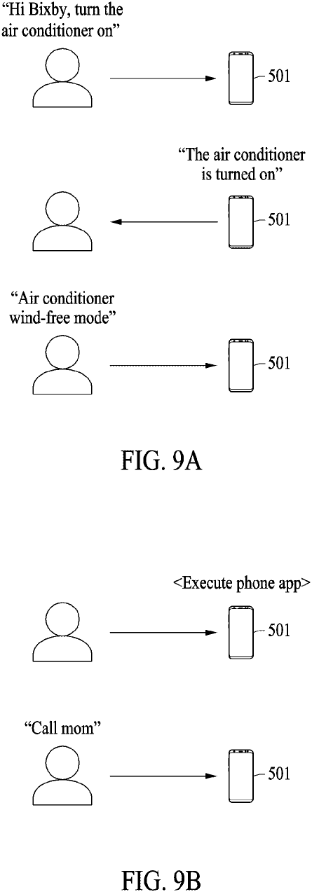

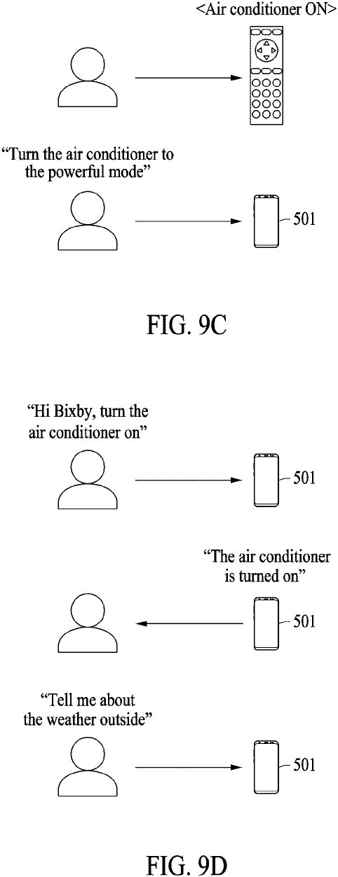

FIGS. 9A to 9D are diagrams illustrating examples in which the electronic device activates the speech recognition service, even when an utterance not including a default wake-up word is received after a user input according to an example embodiment.

Referring to FIG. 9A, according to an example embodiment, the electronic device 501 may activate the speech recognition service in response to a first utterance (e.g., “Hi Bixby, turn the air conditioner on”) of a user including a default wake-up word (e.g., Hi Bixby) and provide feedback (e.g., turning the air conditioner on and then uttering “The air conditioner is turned on” to the user) on the first utterance (e.g., “Hi Bixby, turn the air conditioner on”). The electronic device 501 may generate a predictive wake-up word (e.g., air conditioner wind-free, air conditioner set at 24 degrees, turn the air conditioner off, or today’s weather) based on a first utterance (e.g., “Hi Bixby, turn the air conditioner on”) and reactivate the speech recognition service in response to a second utterance (e.g., “Air conditioner wind-free mode”) of the user including the predictive wake-up word.

Referring to FIG. 9B, according to an example embodiment, the electronic device 501 may receive a user input (e.g., an action input for performing a task through the electronic device 501 (e.g., execution of a phone app)), generate a predictive wake-up word (e.g., call or text) based on the user input, receive an utterance (e.g., “Call mom”) following the user input within a predetermined period of time, and activate the speech recognition service based on a case where the utterance includes the predictive wake-up word (e.g., call).

Referring to FIG. 9C, according to an example embodiment, the electronic device 501 may receive a user input (e.g., an operation on an external electronic device performed outside the electronic device 501 (e.g., the operation of the air conditioner performed using the air conditioner remote control)), generate a predictive wake-up word (e.g., air conditioner wind-free, air conditioner set at 24 degrees, turn the air conditioner off, or air conditioner powerful mode) based on the user input, receive an utterance (e.g., “Turn the air conditioner to the powerful mode”) following the user input within the predetermined period of time, and activate the speech recognition service based on a case where the utterance includes the predictive wake-up word (e.g., air conditioner powerful mode).

Referring to FIG. 9D, according to an example embodiment, the electronic device 501 may activate the speech recognition service in response to a first utterance (e.g., “Hi Bixby, turn the air conditioner on”) of a user including a default wake-up word (e.g., Hi Bixby) and provide feedback (e.g., turning the air conditioner on and then uttering “The air conditioner is turned on” to the user) on the first utterance (e.g., “Hi Bixby, turn the air conditioner on”). The electronic device 501 may generate a predictive wake-up word (e.g., air conditioner set at 24 degrees, turn the air conditioner off, today’s weather, or the weather outside) corresponding to the first utterance (e.g., “Hi Bixby, turn the air conditioner on”). The domain (e.g., the IoT domain) corresponding to the first utterance (e.g., “Hi Bixby, turn the air conditioner on”) may be different from the domain (e.g., a weather domain) corresponding to the predictive wake-up word (e.g., weather today or weather outside), and the electronic device 501 may reactivate the speech recognition service in response to a second utterance (e.g., “Tell me about the weather outside”) of a user including the predictive wake-up word (e.g., weather outside).

According to an example embodiment, the electronic device 501 may generate the predictive wake-up word based on various user inputs (e.g., a voice input, an action input for performing a task through the electronic device, or an action on the external electronic device performed outside the electronic device), thereby increasing the user’s convenience. The electronic device 501 may generate various predictive wake-up words considering both the action data and the utterance data of a user (e.g., all users or an individual user) associated with the domain corresponding to the user input.

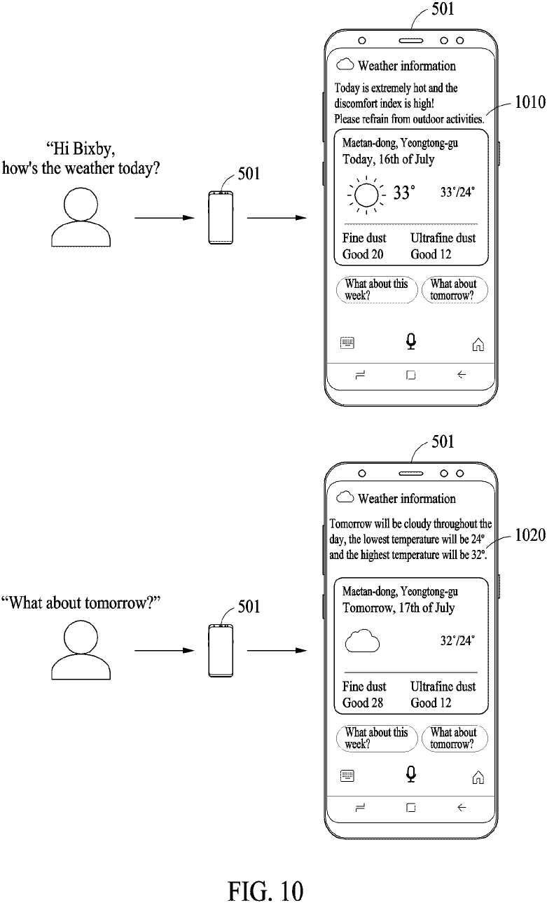

FIG. 10 is a diagram illustrating examples in which an electronic device provides feedback in response to a user input according to an example embodiment.

According to an example embodiment, the electronic device 501 may activate the speech recognition service in response to a first utterance (e.g., “Hi Bixby, how’s the weather today?”) of a user including a default wake-up word (e.g., Hi Bixby), and provide feedback on the first utterance. For example, the electronic device 501 may provide text information on the first utterance to the user on a screen 1010. The electronic device 501 may generate a predictive wake-up word (e.g., what about this week? or what about tomorrow?) based on the first utterance (e.g., “Hi Bixby, how’s the weather today?”) and provide the predictive wake-up word to the user on the screen 1010.

According to an example embodiment, the electronic device 501 may reactivate the speech recognition service in response to a second utterance (e.g., “What about tomorrow?”) of a user including the predictive wake-up word (e.g., what about this week? or what about tomorrow?) and provide feedback on the second utterance. The electronic device 501 may provide text information on the second utterance to the user on a screen 1020.

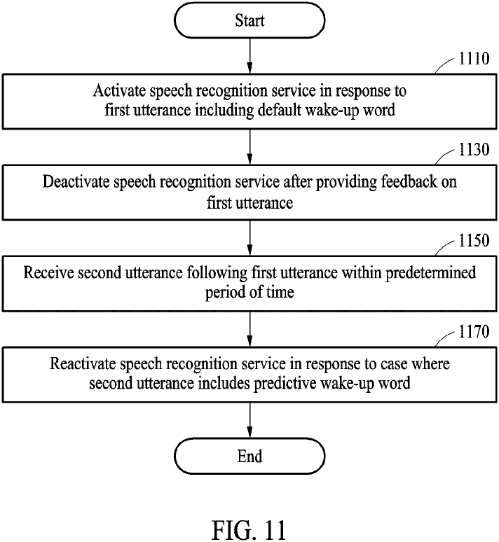

FIG. 11 is a flowchart illustrating an example of an operating method of an electronic device according to an example embodiment.

Operations 1110 through 1170 may be performed sequentially, but not be necessarily performed sequentially. For example, the order of operations 1110 through 1170 may change, and at least two of operations 1110 through 1170 may be performed in parallel.

In operation 1110, the processor (e.g., the processor 520 of FIG. 6) may activate the speech recognition service in response to a first utterance including a default wake-up word. Each “processor” herein comprises processing circuitry.

In operation 1130, the processor 520 may deactivate the speech recognition service after providing feedback on the first utterance.

In operation 1150, the processor 520 may receive a second utterance following the first utterance within a predetermined period of time.

In operation 1170, the processor 520 may reactivate the speech recognition service based on a case where the second utterance includes the predictive wake-up word.

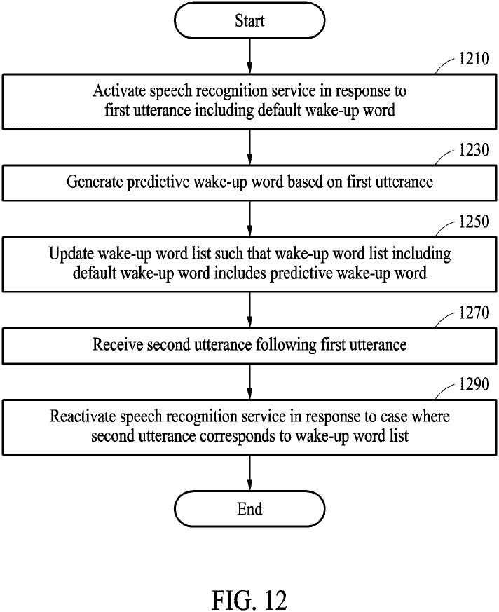

FIG. 12 is a flowchart illustrating another example of the operating method of the electronic device according to an example embodiment.

Operations 1210 through 1290 may be performed sequentially, but not be necessarily performed sequentially. For example, the order of operations 1210 through 1290 may change, and at least two of operations 1210 through 1290 may be performed in parallel.

In operation 1210, the processor (e.g., the processor 520 of FIG. 6) may activate the speech recognition service in response to a first utterance including a default wake-up word.

In operation 1230, the processor 520 may generate a predictive wake-up word based on the first utterance.

In operation 1250, the processor 520 may update a wake-up word list such that the wake-up word list including the default wake-up word includes the predictive wake-up word.

In operation 1270, the processor 520 may receive a second utterance following the first utterance.

In operation 1290, the processor 520 may reactivate the speech recognition service based on a case where the second utterance matches to the wake-up word list.

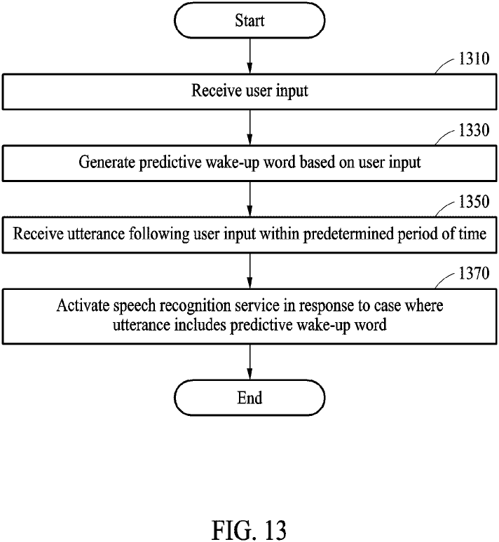

FIG. 13 is a flowchart illustrating still another example of the operating method of the electronic device according to an example embodiment.

Operations 1310 through 1370 may be performed sequentially, but not be necessarily performed sequentially. For example, the order of operations 1310 through 1370 may change, and at least two of operations 1310 through 1370 may be performed in parallel.

In operation 1310, the processor (e.g., the processor 520 of FIG. 6) may receive a user input.

In operation 1330, the processor 520 may generate a predictive wake-up word based on the user input.

In operation 1350, the processor 520 may receive an utterance following the user input within a predetermined period of time.

In operation 1370, the processor 520 may activate the speech recognition service based on a case where the utterance includes the predictive wake-up word.

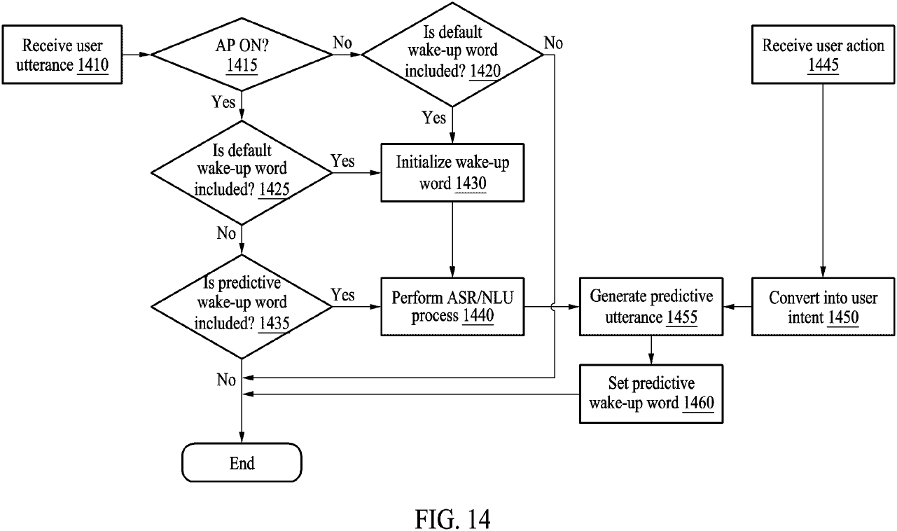

FIG. 14 is a flowchart illustrating a still another example of the operating method of the electronic device according to an example embodiment.

Operations 1410 through 1460 may be performed sequentially, but not be necessarily performed sequentially. For example, the order of operations 1410 through 1460 may change, and at least two of operations 1410 through 1460 may be performed in parallel.

In operation 1410, the processor (e.g., the processor 520 of FIG. 6) may receive a user utterance.

In operation 1415, it may be confirmed whether the processor 520 is in an activated state.

In operation 1420, when the user utterance includes the default wake-up word, the processor 520 in a deactivated state may be activated and the processor 520 may activate the speech recognition service. When the user utterance does not include the default wake-up word, the procedure may end.

In operation 1425, the processor 520 may activate the speech recognition service when the user utterance includes the default wake-up word.

In operation 1430, the processor 520 may initialize the wake-up word list, as the speech recognition service is activated based on the user utterance including the default wake-up word. For example, in the wake-up word list, the default wake-up word may be maintained, and a previously generated predictive wake-up word may be initialized (or removed).

In operation 1435, the processor 520 may activate the speech recognition service when the user utterance does not include the default wake-up word but includes the predictive wake-up word. When the user utterance does not include the default wake-up word and the predictive wake-up word, the procedure may end.

In operation 1440, the processor 520 may convert the user utterance into text data and the processor 520 may obtain a user intent from the text data.

In operation 1445, the processor 520 may receive a user action (e.g., an action input for performing a task through an electronic device (e.g., the electronic device 501 of FIG. 5) or an action on an external electronic device performed outside the electronic device 501).

In operation 1450, the processor 520 may obtain a user intent, based on the user input and a domain corresponding to the user input.

In operation 1455, the processor 520 may generate a predictive utterance that may be received following the user input, based on the user intent and the domain.

In operation 1460, the processor 520 may set the predictive utterance to the predictive wake-up word and the procedure may end.

An electronic device (e.g., the electronic device 501 of FIG. 5) according to an example embodiment may include a memory storing instructions, and a processor electrically connected, directly or indirectly, to the memory and configured to execute the instructions, and when the processor executes the instructions, the processor may be configured to activate a speech recognition service in response to a first utterance including a default wake-up word, deactivate the speech recognition service after providing feedback on the first utterance, receive a second utterance following the first utterance within a predetermined period of time, and reactivate the speech recognition service based on a case where the second utterance includes a predictive wake-up word.

According to an example embodiment, the processor may be configured to obtain a user intent corresponding to the first utterance and a domain for performing a task corresponding to the first utterance, and generate the predictive wake-up word, based on the user intent and the domain.

According to an example embodiment, the processor may be configured to generate the predictive wake-up word, based on the user intent, action data of all users associated with the domain, and utterance data of all users associated with the domain.

According to an example embodiment, the processor may be configured to generate a first intent, based on the user intent and the action data, and generate a second intent, based on the user intent and the utterance data.

According to an example embodiment, the processor may be configured to generate a predictive utterance, based on utterance data of an individual user associated with the first intent and the second intent, and set the predictive utterance to the predictive wake-up word.

According to an example embodiment, the processor may be configured to initialize the predictive wake-up word, when the speech recognition service is reactivated in response to the default wake-up word or when the predetermined period of time has elapsed.

An electronic device 501 according to an example embodiment may include a memory storing instructions, and a processor electrically connected to the memory and configured to execute the instructions, and when the processor executes the instructions, the processor may be configured to activate a speech recognition service in response to a first utterance including a default wake-up word, generate a predictive wake-up word based on the first utterance, update a wake-up word list including the default wake-up word such that the wake-up word list includes the predictive wake-up word, receive a second utterance following the first utterance, and reactivate the speech recognition service based on a case where the second utterance matches to the wake-up word list.

According to an example embodiment, the processor may be configured to obtain a user intent corresponding to the first utterance and a domain for performing a task corresponding to the first utterance, and generate the predictive wake-up word, based on the user intent and the domain.

According to an example embodiment, the processor may be configured to generate the predictive wake-up word, based on the user intent, action data of all users associated with the domain, and utterance data of all users associated with the domain.

According to an example embodiment, the processor may be configured to generate a first intent, based on the user intent and the action data, and generate a second intent, based on the user intent and the utterance data.

According to an example embodiment, the processor may be configured to generate a predictive utterance, based on utterance data of an individual user associated with the first intent and the second intent, and set the predictive utterance to the predictive wake-up word.

According to an example embodiment, the processor may be configured to initialize the wake-up word list when the speech recognition service is reactivated in response to the default wake-up word.

An electronic device 501 according to an example embodiment may include a memory storing instructions, and a processor electrically connected to the memory and configured to execute the instructions, and when the processor executes the instructions, the processor may be configured to receive a user input, generate a predictive wake-up word based on the user input, receive an utterance following the user input within a predetermined period of time, and activate a speech recognition service based on a case where the utterance includes the predictive wake-up word.

According to an example embodiment, user input may include a voice input, an action input for performing a task through the electronic device, or an action on an external electronic device performed outside the electronic device.

According to an example embodiment, the voice input may include a default wake-up word for activating the speech recognition service, and the utterance may include the default wake-up word or the predictive wake-up word for activating the speech recognition service, e.g., only within the predetermined period of time.

According to an example embodiment, the processor may be configured to obtain a user intent based on the user input and a domain corresponding to the user input, and generate the predictive wake-up word, based on the user intent and the domain.

According to an example embodiment, the processor may be configured to generate the predictive wake-up word, based on the user intent, action data of all users associated with the domain, and utterance data of all users associated with the domain.

According to an example embodiment, the processor may be configured to generate a first intent, based on the user intent and the action data, and generate a second intent, based on the user intent and the utterance data.

According to an example embodiment, the processor may be configured to generate a predictive utterance, based on utterance data of an individual user associated with the first intent and the second intent, and set the predictive utterance to the predictive wake-up word. “Based on” as used herein covers based at least on,

Each embodiment herein may be used in combination with any other embodiment(s) described herein.According to an example embodiment, the processor may be configured to initialize the predictive wake-up word, when the speech recognition service is activated in response to a default wake-up word or when the predetermined period of time has elapsed.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device, comprising:
a memory for storing instructions; and
at least one processor electrically connected to the memory and configured to execute the instructions,
wherein, the at least one processor is configured to:
activate a speech recognition service in response to a first utterance comprising a default wake-up word;
deactivate the speech recognition service after providing feedback on the first utterance;
receive a second utterance following the first utterance within a predetermined period of time; and
reactivate the speech recognition service based on a case where the second utterance comprises a predictive wake-up word.

2. The electronic device of claim 1, wherein the at least one processor is configured to:
determine a user intent corresponding to the first utterance and a domain for performing a task corresponding to the first utterance; and
generate the predictive wake-up word, based on the user intent and the domain.

3. The electronic device of claim 2, wherein the at least one processor is configured to generate the predictive wake-up word based on the user intent, action data of all users associated with the domain, and utterance data of all users associated with the domain.

4. The electronic device of claim 3, wherein the at least one processor is configured to:
generate a first intent, based on the user intent and the action data; and
generate a second intent, based on the user intent and the utterance data.

5. The electronic device of claim 4, wherein the at least one processor is configured to:
generate a predictive utterance, based on utterance data of an individual user associated with the first intent and the second intent; and
set the predictive utterance to the predictive wake-up word.

6. The electronic device of claim 1, wherein the at least one processor is configured to initialize the predictive wake-up word, based on the speech recognition service being reactivated in response to the default wake-up word and/or based on the predetermined period of time having elapsed.

7. An electronic device, comprising:
a memory storing instructions; and
at least one processor electrically connected to the memory and configured to execute the instructions,
wherein the at least one processor is configured to:
activate a speech recognition service in response to a first utterance comprising a default wake-up word;
generate a predictive wake-up word based on the first utterance;
update a wake-up word list comprising the default wake-up word so that the wake-up word list comprises the predictive wake-up word;
receive a second utterance following the first utterance; and
reactivate the speech recognition service based on a case where the second utterance matches to the wake-up word list.

8. The electronic device of claim 7, wherein the at least one processor is configured to:
obtain a user intent corresponding to the first utterance and a domain for performing a task corresponding to the first utterance; and
generate the predictive wake-up word, based on the user intent and the domain.

9. The electronic device of claim 8, wherein the at least one processor is configured to generate the predictive wake-up word based on the user intent, action data of all users associated with the domain, and utterance data of all users associated with the domain.

10. The electronic device of claim 9, wherein the at least one processor is configured to:
generate a first intent, based on the user intent and the action data; and
generate a second intent, based on the user intent and the utterance data.

11. The electronic device of claim 10, wherein the at least one processor is configured to:
generate a predictive utterance based on utterance data of an individual user associated with the first intent and the second intent; and
set the predictive utterance to the predictive wake-up word.

12. The electronic device of claim 7, wherein the at least one processor is configured to initialize the wake-up word list based on the speech recognition service being reactivated in response to the default wake-up word.

13. An electronic device, comprising:
a memory storing instructions; and
at least one processor electrically connected to the memory and configured to execute the instructions,
wherein the at least one processor is configured to:
receive a user input;
generate a predictive wake-up word based on the user input;
receive an utterance following the user input within a predetermined period of time; and
activate a speech recognition service based on a case where the utterance comprises the predictive wake-up word.

14. The electronic device of claim 13, wherein the user input comprises at least one of: a voice input, an action input for performing a task through the electronic device, or an action on an external electronic device performed outside the electronic device.

15. The electronic device of claim 14, wherein
the voice input comprises a default wake-up word for activating the speech recognition service, and
the utterance comprises the default wake-up word and/or the predictive wake-up word for activating the speech recognition service only within the predetermined period of time.

16. The electronic device of claim 15, wherein the at least one processor is configured to:
determine a user intent, based on the user input and a domain corresponding to the user input; and
generate the predictive wake-up word, based on the user intent and the domain.

17. The electronic device of claim 16, wherein the at least one processor is configured to generate the predictive wake-up word based on the user intent, action data of all users associated with the domain, and utterance data of all users associated with the domain.

18. The electronic device of claim 17, wherein the at least one processor is configured to:
generate a first intent based on the user intent and the action data; and
generate a second intent based on the user intent and the utterance data.

19. The electronic device of claim 18, wherein the at least one processor is configured to:
generate a predictive utterance based on utterance data of an individual user associated with the first intent and the second intent; and
set the predictive utterance to the predictive wake-up word.

20. The electronic device of claim 13, wherein the at least one processor is configured to initialize the predictive wake-up word based on the speech recognition service being activated in response to a default wake-up word and/or based on the predetermined period of time having elapsed.
